(19) United States
(12) Patent Application Publication
(10) Pub. No.: US 2019/0159488 A1
(43) Pub. Date: May 30, 2019

(54) COLD-SOAKED OATMEALS AND METHODS FOR MANUFACTURING

(71) Applicant: Mush Foods, Inc., Vista, CA (US)

(72) Inventors: Ashley Thompson, Vista, CA (US); Katherine Thomas, Vista, CA (US); Guillermo Freile, Vista, CA (US)

(21) Appl. No.: 16/199,775

(22) Filed: Nov. 26, 2018

Related U.S. Application Data
(60) Provisional application No. 62/590,557, filed on Nov. 25, 2017.

(51) Int. Cl. A23L 7/10

(52) U.S. Cl. CPC A23L 7/10; A23V 2250/5482; A23V 2300/46; A23V 2002/00

(57) ABSTRACT

The present disclosure provides methods of making cold-soaked oatmeal by subjecting a mixture comprising raw oats and liquid to high pressure pasteurization, as well as cold-soaked oatmeals with improved shelf life and/or texture characteristics.

### CROSS-REFERENCE TO RELATED APPLICATION

This application claims the benefit of U.S. Provisional Patent Application No. 62/590,557, filed Nov. 25, 2017, which is hereby incorporated by reference herein in its entirety.

### FIELD OF THE INVENTION

This disclosure generally relates to cold-soaked oatmeals and methods for manufacturing such oatmeals.

### BACKGROUND

Cold-soaked oatmeal is a food product comprising raw oats and liquid that is consumed uncooked after the oats have sufficiently soaked (e.g., as a breakfast). Cold-soaked oatmeals have become increasingly popular in recent years due to interest from health-conscious consumers, as well as from consumers who favor the texture of cold-soaked oatmeal. The texture characteristics of cold-soaked oatmeals include a spoonable and generally spongy consistency while maintaining within the oatmeal recognizable oats. Some individuals also prefer cold-soaked oatmeals because they are enjoyable at room or refrigerated temperatures, in contrast to traditional heated oatmeals.

Cold-soaked oatmeals are understood to provide health benefits, e.g., sufficiently soaking raw oats in liquid at room or refrigerated temperatures breaks down phytic acid in the oats without deactivating food enzymes through heat. Phytic acid binds to certain dietary minerals including, without limitation, iron, zinc, manganese, and to a lesser extent, calcium, and slows their absorption in the body. When phytic acid binds to minerals, they are known as phytates. Phytates reduce the digestibility of starches, proteins, and fats. Therefore, by breaking down phytic acid, this slowed absorption and reduced digestibility is avoided, resulting in increased absorption of nutrients and minerals in the oatmeal. Avoiding heating that could deactivate food enzymes found in raw oats and other possible oatmeal ingredients is important to health conscious individuals as well because food enzymes are understood to aid digestion.

Traditional methods for making cold-soaked oatmeals require soaking raw oats in liquid either at room or refrigerator temperature. All known methods require soaking for about 12 hours in order to achieve the desired breakdown of phytic acid and texture characteristics. However, such methods suffer at least two significant drawbacks. One drawback relates to the significant amount of time required to soak the oats in liquid—e.g., about 12 hours. This bottleneck results in typical product lead times of at least about 12 hours, if not more. This lengthy soaking process also presents a sizable window of time for potential product contamination and other risks to the product during soaking. Another drawback of current methods is the limited shelf life of cold-soaked oatmeal produced by such methods, which is typically from about 5 days to about 7 days, depending on the temperature and level of humidity during storage. The limited shelf life of cold-soaked oatmeal produced according to current methods consequently limits the range of distribution from the manufacturing site and, consequently, consumer access to such products. The shelf life also requires frequent manufacturing runs in order to provide a consistent source of unexpired product.

### BRIEF SUMMARY

In view of the shortcomings of cold-soaked oatmeal produced according to current methods, there exists a need in the art for new methods of manufacturing cold-soaked oatmeal with an improved shelf life and/or which require less processing time (e.g., avoiding the ˜12 hour soak time required by current methods). The present disclosure addresses these needs by providing cold-soaked oatmeal compositions which can be manufactured quickly and which display improved shelf life, among other benefits described herein and/or inherent to such compositions. Methods of manufacturing improved cold-soaked oatmeal compositions and food products comprising the same are also provided. Accordingly, the present disclosure presents multiple advances to the current state of the art. In some aspects of the disclosure, inventors discovered a manufacturing process that significantly decreases the time required to soak the oats in liquid to produce cold-soaked oatmeal and, therefore, overcomes at least one significant shortcoming of traditional methods. The cold-soaked oatmeals described herein have also been found to possess unexpectedly improved shelf life and/or texture characteristics, providing further benefits compared to traditional cold-soaked oatmeals.

In some exemplary aspects, the describes provides oatmeal mixtures which may include a plurality of raw oats and a liquid, wherein at least a portion of the liquid is absorbed by the plurality of raw oats; and wherein the oatmeal mixture has been subjected to a high pressure pasteurization (HPP) process. In some aspects, the parameters for the HPP process may comprise a pressure of 43,500-95,000 PSI and a temperature of 0-60° F. For example, a pressure of 82,000-92,000 PSI and a temperature of 35-45° F. was be selected.

In some aspects, the HPP process may be carried out to completion within 1-180 minutes or any time-point In some exemplary aspects, the oatmeal mixture may be subjected to the selected temperature and pressure for up to 15 minutes (e.g., up to 1, 2, 3, 4, 5, 6, 7, 8, 9, 10, 11, 12, 13, 14 or 15 minutes), or for a longer duration of time (e.g., up to 30 or 60 minutes) during the HPP process.

The temperature and pressure parameters may be held constant or varied during the HPP process. For example, the oatmeal mixture may be subjected to HPP at about 87,000 PSI and about 40.6° F. for 7-10 minutes

In some exemplary aspects, the plurality of raw oats in the oatmeal mixture may comprise one or more of the following: raw whole rolled oats, raw steel cut oats, and/or raw quick oats. In these and other exemplary aspects, the liquid may comprise one or more of the following: water, juice, animal milk, yogurt, dairy free nut milk, coconut milk, chocolate milk, chocolate almond milk, and/or coconut water.

The oatmeal mixture may also include one or more sweeteners, seasonings, fruits, nuts, and/or seeds. Exemplary sweeteners include, without limitation: honey, sugar, stevia, and/or chocolate. Exemplary seasonings include, without limitation: salt, sea salt, vanilla extract, cacao powder, cinnamon, nutmeg, and/or pumpkin spice. Exemplary fruits include, without limitation: blueberry, dates, apple, cranberry, banana, pumpkin, strawberry, raspberry, blackberry, mango, melon, peach, pear, grape, apricot, and/or fig. Exemplary nuts include, without limitation: almonds, walnuts, peanuts, pecans, pistachios, cashews, macadamia nuts, brazil nuts, and/or hazelnuts. Exemplary seeds include, without limitation: sunflower, chia, pumpkin, and/or flax seeds. Any of the foregoing sweeteners, seasonings, fruits, nuts, and/or seeds may be included as extracts, in whole, ground or crushed form, or as pieces or sections of a whole. For example, the oatmeal mixture may include whole blueberries, crushed apple, ground cinnamon, apple extract, etc.

In some exemplary aspects, oatmeal mixtures prepared according to the disclosure may have an improved shelf life. For example, the oatmeal mixture may have a shelf life of at least 10, 20, 30, 40, 50 or 60 days when maintained at a temperature of 40° F., the shelf life being measured from the date that the HPP process is completed.

In some exemplary aspects, oatmeal mixtures prepared according to the disclosure may have an improved consistency (e.g., mushier, creamier, and/or thicker) compared to cold-soaked oatmeals prepared according to traditional methods. For example, an oatmeal mixture prepared according to the disclosure (e.g., using an HPP process with the temperature and pressure parameters described herein) may have an increased viscosity and/or density compared to a control sample which contains the same components but is instead cold-soaked in the same liquid at room temperature and 14.7 PSI of pressure for the same duration of time as the HPP process.

The disclosure also provides methods of manufacturing an oatmeal mixture, which in some aspects may include: a) placing a plurality of raw oats and a liquid in a container; b) sealing the container; and c) subjecting the container to an HPP process. The plurality of raw oats may be mixed with the liquid to form a uniform mixture, prior to or after adding the plurality of raw oats and the liquid to the container. In some exemplary aspects, the HPP process used during the method may include a pressure of 43,500-95,000 PSI, and a temperature of 0-60° F. The HPP process may be carried out to completion within up to 15 minutes (e.g., up to 1, 2, 3, 4, 5, 6, 7, 8, 9, 10, 11, 12, 13, 14 or 15 minutes), or within a longer duration of time (e.g., up to 30 or 60 minutes). In some exemplary aspects, the HPP process used during the method may include a pressure of 82,000-92,000 PSI, a temperature of 35-45° F., and be carried out to completion within 15 minutes or less. For example, the HPP process used during the method may maintain a pressure of at least 80,000 PSI and a temperature of 30-50° F. for 5-15 minutes.

In still further aspects of the disclosure, oatmeal products are provided. Such oatmeal products may comprise a container having a lid and seal, wherein the container contains an oatmeal mixture as described herein. In some exemplary aspects, the oatmeal product includes an oatmeal mixture that was heated to a maximum temperature of 50° F. or less during the HPP process. In other exemplary aspects, the maximum temperature of the oatmeal mixture during the HPP process may be 30, 35, 40, 45, 50, 55, 60, 65, 70° F. or less. Oatmeal products produced according to the disclosure may include an oatmeal mixture which has an improved consistency and/or shelf life (e.g., a shelf life of up to 30, 40, 50 or 60 days).

The above simplified summary of exemplary aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and particularly pointed out in the claims.

### BRIEF DESCRIPTION OF THE FIGURES

The accompanying drawings, which are incorporated into and constitute a part of this specification, illustrate one or more example embodiments of the invention and, together with the detailed description serve to explain their principles and implementations.

FIG. 1 shows a top perspective view of a cold-soaked oatmeal mixture in accordance with an exemplary aspect of the disclosure, shown in an open container.

FIG. 2 shows a side perspective view of the cold-soaked oatmeal mixture of FIG. 1. FIG. 2 further shows this cold-soaked oatmeal mixture on a scale having a mass of 0.170 Kg.

FIG. 3 shows a top perspective view of an oatmeal mixture containing raw oats and liquid in an open container. At the time of this photograph, the oats had been soaking in the liquid for approximately 10 minutes at room temperature (approximately 73.4° F.) and 1 atm of pressure (approximately 14.7 PSI).

FIG. 4 shows a side perspective view of the oatmeal mixture of FIG. 3. FIG. 4 further shows this oatmeal mixture on a scale having a mass of 0.170 Kg.

FIG. 5 shows a top perspective view the cold-soaked oatmeal mixture of FIG. 1 (top) which was subjected to HPP processing, and top perspective view of the oatmeal mixture of FIG. 3 (bottom), which was prepared using a traditional method without HPP processing.

FIG. 6 shows a top perspective view of a cold-soaked oatmeal in an open container made in accordance with a traditional method (e.g., without HPP processing). At the time of this photograph, the oats had been soaking in the liquid for approximately 12 hours at room temperature (approximately 73.4° F.) and 1 atm of pressure (approximately 14.7 PSI).

FIG. 7 shows another top perspective view of the cold-soaked oatmeal of FIG. 6.

FIG. 8 shows a side perspective view of the cold-soaked oatmeal of FIG. 6.

FIG. 9A and FIG. 9B show representative supervisory control and data acquisition (SCADA) data for the high pressure pasteurization step used in making cold-soaked oatmeal in accordance with exemplary aspects of the disclosure.

FIG. 10A and FIG. 10B show representative data relating to the shelf life of a cold-soaked oatmeal in accordance with exemplary aspects of the disclosure.

### DETAILED DESCRIPTION

Methods for making cold-soaked oatmeal mixtures using high pressure pasteurization (“HPP”) in accordance with the disclosure, as well as oatmeal products with improved shelf life and/or texture, are described in detail below. The following description includes references to the accompanying drawing. In the drawings, the same reference numeral is used to represent the same part or a corresponding part so as to avoid repeated explanation. Those of ordinary skill in the art will realize that the following description is illustrative only and is not intended to be in any way limiting. Other aspects will readily suggest themselves to those skilled in the art having the benefit of this disclosure.

An exemplary method of making a cold-soaked oatmeal mixture in accordance with the disclosure comprising the steps (1) preparing an oatmeal mixture comprising raw oats and at least one liquid and (2) subjecting the oatmeal mixture to an HPP process. As described in further detail below, HPP processing generally refers to a cold pasteurization technique whereby the oatmeal mixture is placed in a sealed container and subjected to high pressure (e.g., 43,500-95,000 PSI) at a temperature (e.g., 30-60° F.) sufficient to kill or inactivate microorganisms (e.g., yeast, bacteria) in the oatmeal mixture, increasing the shelf life of the HPP-treated oatmeal mixture.

The raw oats used in the oatmeal mixture may include any oats known in the art and, while not intending to be limited, examples include raw whole rolled oats, raw steel cut oats, and raw quick oats. Suitable liquids similarly include those known in the art and, while not intending to be limited, examples include water, juice, animal milk, yogurt, dairy free nut milk, coconut milk, chocolate milk, chocolate almond milk, and coconut water.

Optionally, the mixture may include one or more additional ingredients. Such ingredients may include for example, sweeteners, seasoning, fruits, nuts, and seeds known in the art (e.g., used in traditional oatmeals). Exemplary sweeteners include, without limitation: honey, sugar, stevia, and/or chocolate. Exemplary seasonings include, without limitation: salt, sea salt, vanilla extract, cacao powder, cinnamon, nutmeg, and/or pumpkin spice. Exemplary fruits include, without limitation: blueberry, dates, apple, cranberry, banana, pumpkin, strawberry, raspberry, blackberry, mango, melon, peach, pear, grape, apricot, and/or fig. Exemplary nuts include, without limitation: almonds, walnuts, peanuts, pecans, pistachios, cashews, macadamia nuts, brazil nuts, and/or hazelnuts. Exemplary seeds include, without limitation: sunflower, chia, pumpkin, and/or flax seeds. Any of the foregoing sweeteners, seasonings, fruits, nuts, and/or seeds may be included as extracts, in whole, ground or crushed form, or as pieces or sections of a whole. For example, the oatmeal mixture may include whole blueberries, crushed apple, ground cinnamon, apple extract, etc.

The mixture may be prepared according to known techniques, e.g., by manually or mechanically stirring and/or blending raw oats and at least one liquid, plus any of the optional components described herein. In one exemplary aspect, these ingredients are mixed thoroughly to ensure even distribution. In another embodiment, first the dry ingredients are mixed together to ensure even distribution, second the wet ingredients are blended together to create a wet mixture, and third the dry and wet mixtures are added together. It is understood that any order of mixing of the various components described herein may be carried out as desired for a given implementation.

In order to subject the mixture to a HPP process, the mixture must first be placed into a container (e.g., its intended final package) and sealed, wherein the selected container and seal are suitable for HPP processing. HPP-compatible containers (e.g., plastic container) and seals (e.g., high density polyethylene (HDPE) film) are known in the art. In one exemplary aspect, a bulk oatmeal mixture is prepared and transferred into a pneumatic filler which is used to fill plastic containers with smaller portions of the oatmeal mixture. The plastic containers holding the smaller portions of the mixture may then be sealed with HDPE film and subjected to an HPP process.

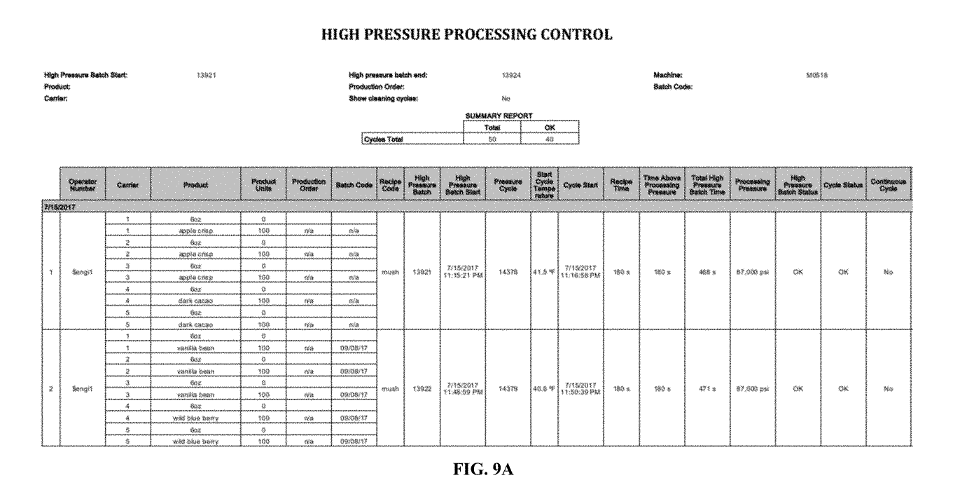

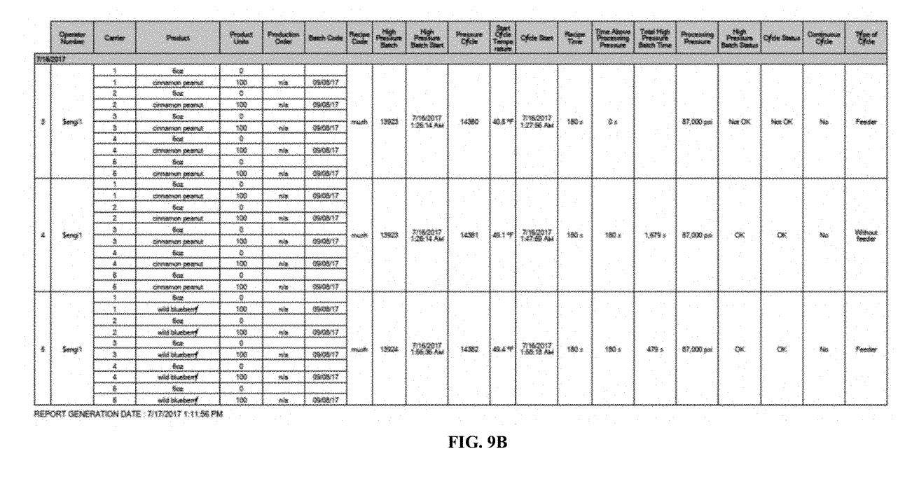

After the oatmeal mixture has been placed in a container (e.g., its intended final package) and sealed, the container may be subjected to HPP. Generally stated, HPP processing proceeds by loading one or more unprocessed containers into a hyperbaric vessel, which is then filled with a volume of water sufficient to produce a desired level of pressure for a selected amount of time and temperature. The pressure and temperature levels may be held constant or varied during this stage (e.g., by adjusting the volume of water). Finally, the pressure is removed and the HPP-processed packages are unloaded from the hyperbaric vessel. FIG. 9A and FIG. 9B show representative supervisory control and data acquisition (SCADA) data relating to subjecting an oatmeal mixture to HPP in accordance with an exemplary aspect of the disclosure.

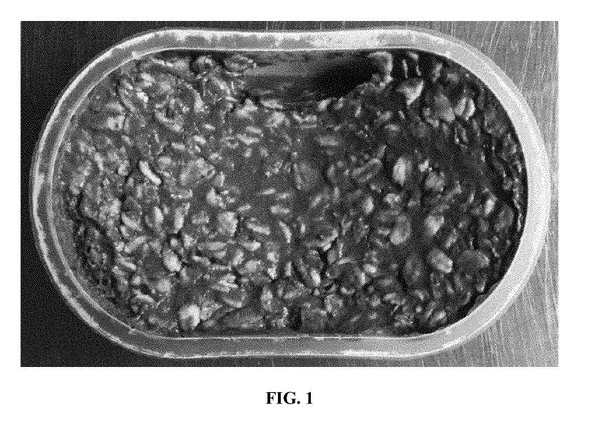

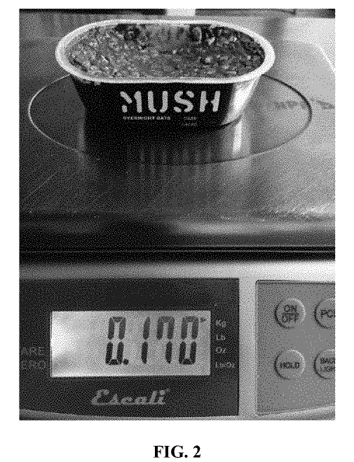

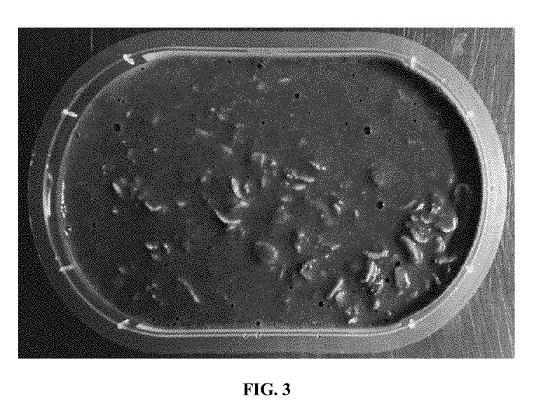

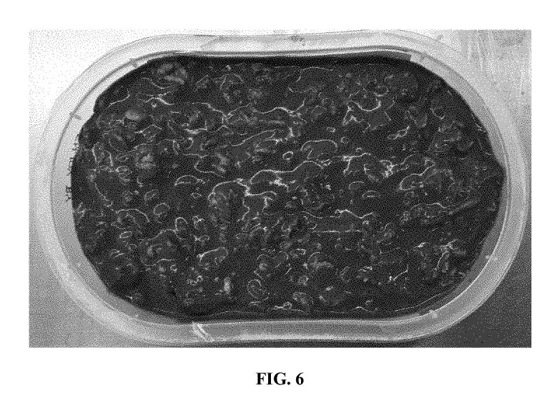

FIG. 1 shows a top perspective view of a cold-soaked oatmeal mixture in packaging in accordance with an exemplary aspect of the disclosure. The seal on the package has been removed so that the texture characteristics of the cold-soaked oatmeal can be better seen. FIG. 2 shows a side perspective view of the cold-soaked oatmeal of FIG. 1. FIG. 2 further shows the cold-soaked oatmeal having a mass of 0.170 Kg. The oats in FIG. 1 and FIG. 2 had been soaking in the liquid mixture for only about 10 minutes at the time that this photograph was recorded, 7 minutes and 51 seconds of which have been in the HPP hyperbaric vessel at conditions of 87,000 PSI and 40.6 degrees Fahrenheit. As illustrated by these figures, the oats have absorbed the liquid mixture in its entirety and have a higher viscosity level and density than the oats shown in FIG. 3 and FIG. 6 which were not subjected to HPP processing. For example, in some exemplary aspects the HPP-processed oatmeal mixtures produced in accordance with the disclosure may have a density greater than or equal to: 1.0 g/mL, 1.1 g/mL, 1.2 g/mL, 1.3 g/mL, 1.4 g/mL, 1.5 g/mL, 1.6 g/mL, 1.7 g/mL, 1.8 g/mL, 1.9 g/mL, or 2.0 g/mL. In some aspects, the density of the HPP-processed oatmeal mixtures may increase by 10-20%, or any integer value within this range, compared to an otherwise identical sample which has not been subjected to HPP. The higher viscosity level and density of the HPP-processed oatmeal mixture (e.g., FIG. 1) is believed to result from air within the oats and liquid being removed during the HPP process, causing the oats to more fully absorb the liquid. The resulting oats are now fully hydrated, producing an oatmeal mixture which typically has a mushier, creamier, and thicker consistency (pudding-like) compared to otherwise identical oatmeal mixtures allowed to cold-soak at room temperature (approximately 73.4° F.) and 1 atm (14.7 PSI) of pressure for the same duration of time as the HPP process.

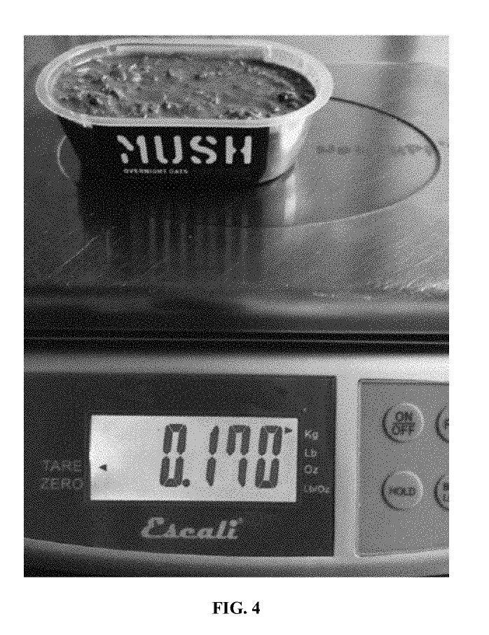

FIG. 3 shows a top perspective view of a mixture of raw oats and liquid in packaging. At the time that this photograph was recorded, the oats had been soaking in the liquid for approximately 10 minutes at room temperature and pressure. FIG. 4 shows a side perspective view of the mixture of FIG. 3, and further shows the mixture having a mass of 0.170 Kg. The mixture is FIG. 3 had been prepared the same way as mixture in FIG. 1 but was not subjected to HPP. FIG. 3 and FIG. 4 show that the oats are still whole or not broken down. These oats were found to possess a crunchy texture in the mouth. FIG. 3 and FIG. 4 further show that the oats have not entirely absorbed the liquid (chocolate almond milk in this case). The oats in FIG. 3 and FIG. 4. possess characteristics like that of a hard grain merely sitting in a liquid.

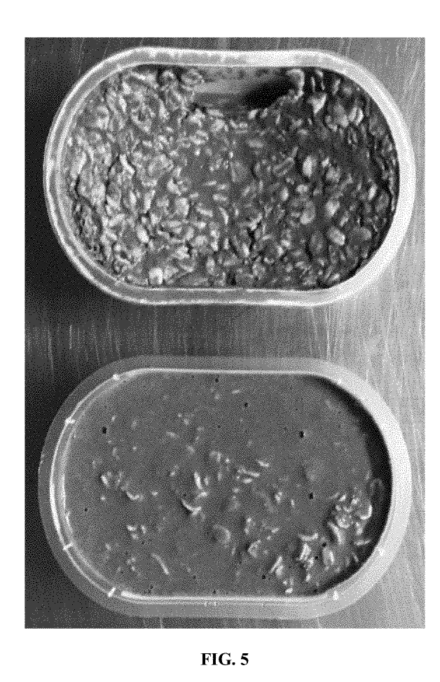

For comparison purposes, FIG. 5 shows a top perspective view the cold-soaked oatmeal mixture of FIG. 1 and top perspective view of the mixture of FIG. 3.

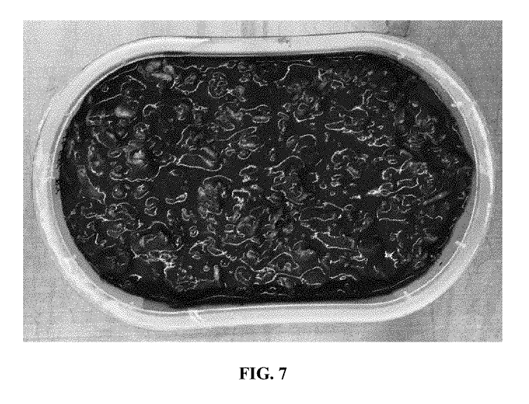

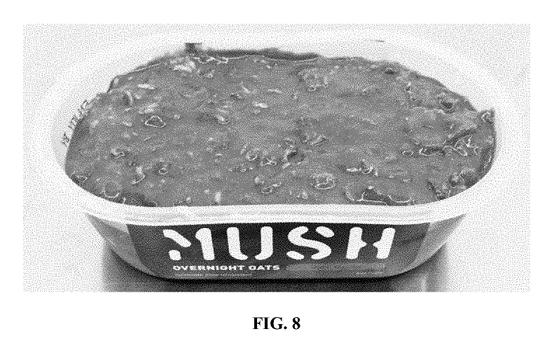

FIG. 6 shows a top perspective view of a cold-soaked oatmeal in an open container made in accordance with a traditional method (not subjected to HPP). The oats had been soaking in the liquid for about 12 hours at room temperature (approximately 73.4° F.) and 1 atm of pressure (approximately 14.7 PSI). FIG. 7 shows another top perspective view of the cold-soaked oatmeal of FIG. 6. FIG. 8 shows a side perspective view of the cold-soaked oatmeal of FIG. 6. The oats in FIG. 6, FIG. 7, and FIG. 8 have absorbed most of the liquid after this 12-hour soaking step. The cold-soaked oatmeal has a spongy-like texture as opposed to characteristics like that of a hard grain merely sitting in a liquid.

Unexpectedly, given the high pressures used in the HPP process, oats in cold-soaked oatmeal mixtures produced by subjecting the mixture to HPP in accordance with the present disclosure do not become obliterated to an unrecognizable state. On the contrary, these cold-soaked oatmeal mixtures have unexpectedly positive texture characteristics including a spoonable and generally pudding-like consistency while maintaining recognizable oats within the oatmeal (e.g., as shown by FIG. 2). In other exemplary aspects, other optional oatmeal ingredients also remain recognizable after the mixture is subjected to HPP.

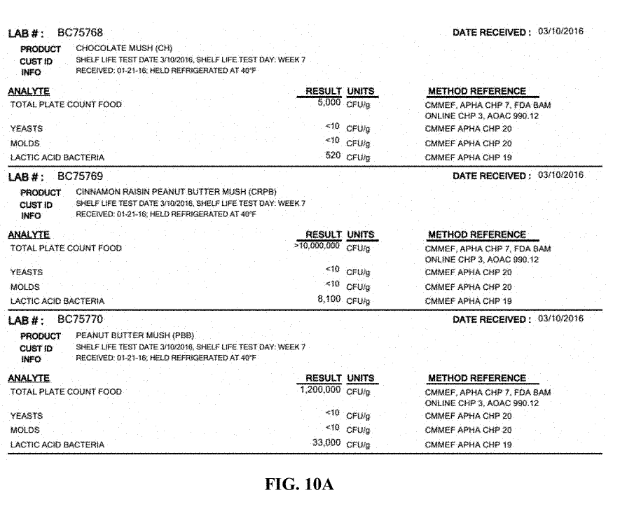

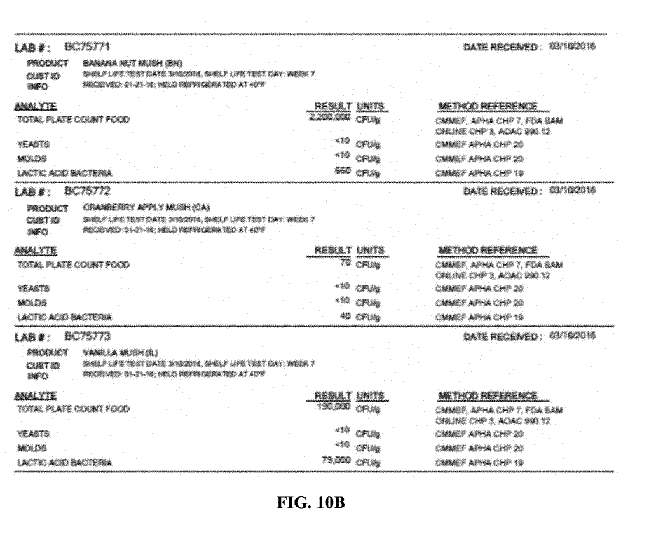

The inclusion of HPP in the manufacturing of cold-soaked oatmeal mixtures has also been found to unexpectedly extend the shelf life of cold-soaked oatmeal mixtures. Cold-soaked oatmeal is a low-acid food and, and consequently, would be expected to have a relatively short shelf life. In contrast, cold-soaked oatmeal mixtures subjected to HPP in accordance with the present disclosure have been found to have extended shelf lives of up to about 60 days. FIG. 10A and FIG. 10B show representative data relating to the shelf life of a cold-soaked oatmeal in accordance with illustrative embodiments of the invention.

In some exemplary aspects, the shelf life of a cold-soaked oatmeal mixture produced according to the disclosure may be determined based upon an upper threshold of microbiological flora in a sample of the oatmeal mixture. For example, in some aspects an oatmeal mixture may be determined to have reached the end of its shelf life when: an aerobic plate count (“APC”) assay exceeds ≥5,000,000 CFU/g, when the concentration of lactic acid bacteria in the sample exceeds ≥5,000,000 CFU/g, when the concentration of yeast in the sample exceeds ≥100,000 CFU/g, and/or when the concentration of mold in the sample exceeds ≥100,000 CFU/g. In some aspects, an oatmeal mixture may be determined to have exceeded its shelf life when visible mold growth is present. It is understood that the shelf life threshold of an oatmeal may be based on any one or a combination of these thresholds. With respect to the APC assay, it is understood that in some aspects this assay may be performed in accordance with the “BAM: Aerobic Plate count” assay described in the Bacteriological Analytical Manual, 8^{th} Ed., Revision A, Ch. 3 (1998), published by the U.S. Food and Drug Administration (“FDA”). This assay may also be performed in accordance with AOAC Official Method 990.12, “Aerobic Plate Count in Foods” With respect to the measurement of lactic acid bacteria, it is understood that the measurement may be made using any the reference methods provided in the Compendium of Methods for the Microbiological Examination of Foods, 4^{th} Ed., Ch. 19.

Methods of manufacturing cold-soaked oatmeal in accordance with the present disclosure allows production of improved cold-soaked oatmeals at significant, commercial scales in short time. In one illustrative and non-limiting example, 1,333 individual servings of improved cold-soaked oatmeal, containing about 500 pounds of cold-soaked oatmeal in total, were manufactured in 28 minutes. First, 500 pounds total of the mixture comprising raw oats and liquid was prepared and put into the vat of a pneumatic filling machine. This stage was complete within 5 minutes. Then, the machine was used to fill and seal 100 individual plastic containers per minute until the mixture was fully transferred to the containers, over a span of 13 minutes. Then, the sealed containers were placed into capsules (approximately 300 containers/capsule) for loading into the HPP device. The capsules were subjected to HPP processing at 87,000 PSI and 40° F. HPP processing of all of the capsules was completed within 10 minutes. At this time-point, 28 minutes had elapsed and 1,333 cold-soaked oatmeal products had been created. The cold-soaked oatmeal mixtures contained in these oatmeal products was found to have superior texture characteristics including a spoonable and generally pudding-like consistency while maintaining recognizable oats within the oatmeal, in addition to an extended shelf life of up to about 60 days.

1. An oatmeal mixture, comprising:
a plurality of raw oats; and
a liquid, wherein at least a portion of the liquid is absorbed by the plurality of raw oats;
wherein the oatmeal mixture has been subjected to a high pressure pasteurization (HPP) process.

2. The oatmeal mixture of claim 1, wherein the HPP process comprises the following parameters:
a pressure of 43,500-95,000 PSI, and
a temperature of 0-60° F.

3. The oatmeal mixture of claim 2, wherein the HPP process is carried out to completion within 60 minutes or less.

4. The oatmeal mixture of claim 1, wherein the HPP process comprises the following parameters:
a pressure of 82,000-92,000 PSI, and
a temperature of 35-45° F.

5. The oatmeal mixture of claim 4, wherein the HPP process is carried out to completion within 15 minutes or less.

6. The oatmeal mixture of claim 4, wherein the oatmeal mixture is subjected to the pressure and the temperature during the HPP process for 5-10 minutes.

7. The oatmeal mixture of claim 1, wherein the plurality of raw oats comprises one or more of the following: raw whole rolled oats, raw steel cut oats, and/or raw quick oats.

8. The oatmeal mixture of claim 1, wherein the liquid comprises one or more of the following: water, juice, animal milk, yogurt, dairy free nut milk, coconut milk, chocolate milk, chocolate almond milk, and/or coconut water.

9. The oatmeal mixture of claim 1, further comprising one or more sweeteners, seasonings, fruits, nuts, and/or seeds, wherein:
a) the one or more sweeteners comprise honey, sugar, stevia, and/or chocolate;
b) the one or more seasonings comprise salt, sea salt, vanilla extract, cacao powder, cinnamon, nutmeg, and/or pumpkin spice;
c) the one or more fruits comprise blueberry, dates, apple, cranberry, banana, pumpkin, strawberry, raspberry, blackberry, mango, melon, peach, pear, grape, apricot, and/or fig;
d) the one or more nuts comprise almonds, walnuts, peanuts, pecans, pistachios, cashews, macadamia nuts, brazil nuts, and/or hazelnuts; and
e) the one or more seeds comprise sunflower, chia, pumpkin, and/or flax seeds.

10. The oatmeal mixture of claim 5, wherein the oatmeal mixture has a shelf life of at least 40 days when maintained at a temperature of 40° F., the shelf life being measured from the date that the HPP process is completed.

11. The oatmeal mixture of claim 5, wherein the oatmeal mixture has an increased viscosity and/or density compared to a control sample comprising the same components and concentrations as the oatmeal mixture which has not been subjected to the HPP process.

12. A method of manufacturing an oatmeal mixture, the method comprising:
a) placing a plurality of raw oats and a liquid in a container;
b) sealing the container; and
c) subjecting the container to a HPP process.

13. The method of claim 12, further comprising a step of mixing the plurality of raw oats and the liquid to form a uniform mixture, prior to or after adding the plurality of raw oats and the liquid to the container.

14. The method of claim 12, wherein the HPP process comprises:
a pressure of 43,500-95,000 PSI, and
a temperature of 0-60° F.

15. The method of claim 14, wherein the HPP process is carried out to completion within 60 minutes or less.

16. The method of claim 12, wherein the HPP process comprises:
a pressure of 82,000-92,000 PSI, and
a temperature of 35-45° F.

17. The method of claim 16, wherein the HPP process is carried out to completion within 15 minutes or less.

18. The method of claim 12, wherein the HPP process comprises a step of maintaining a pressure of at least 80,000 PSI and a temperature of 30-50° F. for 5-15 minutes.

19. An oatmeal product comprising a container having a lid and seal, wherein the container contains the oatmeal mixture of claim 1.

20. The oatmeal product of claim 19, wherein the oatmeal mixture was heated to a maximum temperature of 50° F. or less during the HPP process.
